(19) United States
(12) Patent Application Publication
(10) Pub. No.: US 2013/0181822 A1
(43) Pub. Date: Jul. 18, 2013

(54) METHOD AND TIMER APPARATUS FOR FOB REMOTE

(71) Applicant: Richard Warren Leavitt, Jacksonville, FL (US)

(72) Inventor: Richard Warren Leavitt, Jacksonville, FL (US)

(21) Appl. No.: 13/740,255

(22) Filed: Jan. 13, 2013

Related U.S. Application Data
(60) Provisional application No. 61/586,861, filed on Jan. 16, 2012.

(51) Int. Cl. G08C 17/02

(52) U.S. Cl. CPC G08C 17/02
USPC 340/12.28

(57) ABSTRACT

The present disclosure describes a method and apparatus for actuating one or more wireless FOB remote(s) based on specific user pre-programmed times. The advantage of this device is that it can utilize existing FOBs to automatically lock your vehicle, alarm; close garage without requiring manual intervention after a timer is set. Additionally, the apparatus is compatible with most existing systems without requiring any modifications to them.

### CROSS REFERENCE TO RELATED APPLICATION

This nonprovisional application claims the benefit of Provisional Application No. 61/586,861 filed on Jan. 16, 2012, which is herein incorporated by reference in its entirety.

### STATEMENT REGARDING FEDERALLY SPONSORED RESEARCH

### Not Applicable.

### FIELD OF THE INVENTION

The present disclosure relates to and describes a method and apparatus for actuating a wireless FOB remote. More specifically, an apparatus that is capable of actuating one or more wireless FOB remotes at specific user pre-programmed times.

### BACKGROUND OF THE INVENTION

FOBs vary considerably in size, style and functionality. Currently, wireless FOB remotes are widely incorporated for a variety of applications. For example, wireless FOB remotes are used in keyless entry systems in automobiles, garage door openers, and alarm systems. A wireless FOB remote traditionally consists of at least two buttons. When a button is pressed a wireless coded signal is sent to a receiver or transmitter to activate/de-activate a locking mechanism, alarm, or perform some other programmed function. For example, in most automobiles today, a keyless entry system with a wireless FOB remote comes standard. The keyless entry system can incorporate a wireless FOB remote that includes a “lock” and an “unlock” button. When the lock button is pressed a wireless coded signal is transmitted to the vehicle and the doors automatically lock. Inversely, the car doors can be unlocked by pressing the “unlock” button.

Today, most FOBs used require that the button is pressed manually in order to send a coded signal. One of the weaknesses of those remote keyless entry systems is that the “lock” button on wireless FOB remote must be manually pressed in order to send the coded signal. For example, in car locking systems if the button is not pressed the doors will not lock or unlock.

Other systems that can implement a wireless FOB also work with proximity sensors which unlock when the wireless FOB is in proximity with the car and locks when the FOB leaves a specified range. However, these sensors are expensive and can only be found as options in luxury vehicles with complex security systems.

Likewise, car alarm systems can be complex, expensive and usually require professional installation. Car alarm systems can be programmed to “lock” or “arm” automatically. This feature, though convenient, may lead to nuisance alarms and increase the likelihood of locking the keys in the vehicle.

More recently, multi-functional FOBs have been developed. For example, the to Kolpasky et al., U.S. Pat. No. 7,301,442 describe FOBs that are programmable to lock/unlock, may be voice activated, function as an ice-scraper, and contain a credit card strip and other functionality. Although this patent may address some of the problems the present disclosure can resolve, these multifunctional FOBs are expensive, not practical for existing car/alarm systems, may cause to inadvertently lock car keys and FOB inside automobile, and only function only for a specific car. As a result, there is now a need for new devices that can be universally used with one or more FOB, are practical and inexpensive, to help prevent burglaries at specific times.

The to De Los Santos et al., U.S. Pat. No. 7,499,283 describes a key FOB for an automobile providing a key FOB comprised of a flexible covering that is not subject to breakage and provides assembly without having to align multiple components therefore making assembly easier and cost effective. Although this patent may address some of the problems that the present disclosure can resolve, this key FOB for an automobile is not incorporated with an automatic locking apparatus. As a result, users will remain susceptible to automobile thefts and locking they keys in the vehicle. Therefore there is a need for an automatic universal FOB locking apparatus.

More recently, remote keyless entry transmitter FOBs with RF analyzers have been developed. For example, the to Luo et al., U.S. Pat. No. 7,042,342 combines a remote keyless entry functions and wireless device detection functions in an efficient and cost-effective manner that minimizes power consumption to provide long battery life. Although this patent may address some of the problems that the present disclosure can resolve, these FOBs with RF analyzers are not capable of locking vehicle doors automatically at specific times and are therefore not practical. Therefore, there is a need for an automatic universal FOB locking apparatus.

The to Benzie et al., U.S. Pat. No. 6,583,715 discloses a method and system for unlocking and/or opening at least one openable member of a motor vehicle wherein only a single manually operable switch or button need be provided on a key FOB transmitter until to control each of the doors of the vehicle independently.

Given the foregoing, a cost effective universal FOB apparatus capable of automatically locking a vehicle at a given time is needed.

### SUMMARY OF THE DISCLOSURE

The present disclosure describes an apparatus that is capable of actuating one or more wireless FOB remote(s) at specific user pre-programmed times. In alternate embodiments of the present disclosure, one objective is to allow a programmable timer to be synchronous or to send a signal at the programmed time to a mechanism that is capable of activating one or more wireless FOB remotes. The apparatus may include a housing mechanism for one or more wireless FOB remotes of different sizes, shapes and configurations to be placed and activated accordingly. For example, the housing mechanism may be a universal holder that encompasses a plurality of synthetic based plates which allow the FOB remotes to be incorporated therein. The FOB will then be secured between said plates, which are then fastened via a plurality of thumb screws.

In alternate embodiments, the apparatus may be operable to communicate through Bluetooth, USB cable, etc. with a cell phone, computer or other means, to allow for more detailed programming (e.g., different times on different days of the week or for sending associated alerts to the user). Additionally, alternate embodiments may include a signal strengthening component as a means of amplifying the signal strength ultimately increasing the range of which the FOB would normally reach.

In yet another alternate embodiment, the apparatus may be capable of storing a particular coded FOB signal which may be activated by a programmed timer in the device.

The primary advantages of the present embodiment is that it can be designed to utilize your system's existing wireless FOB remote to automatically lock your vehicle, car garage door, alarm, or other and it does not require manual intervention after the user defined times are set. For example, the times may be programmed to cause a FOB remote to send a lock signal automatically sent to the vehicle locking system in the evening, to consequently, lock the car doors. These embodiments can consequently allow people to use the system's spare wireless FOB remotes, to ensure for example, the car gets locked, alarm gets activated or garage door is closed, or vice versa, at predetermined times and without posing risk of locking your keys inside the vehicle in a way innocuous to the user.

### BRIEF DESCRIPTION OF THE FIGURES

A further understanding of the present disclosure can be obtained by reference to a preferred embodiment set forth in the illustrations of the accompanying drawings. Although the illustrated embodiment is merely exemplary of systems and methods for carrying out the present invention, both the organization and method of operation of the invention, in general, together with further objectives and advantages thereof, may be more easily understood by reference to the drawings and the following description. The drawings are not intended to limit the scope of this disclosure, which is set forth with particularity in the claims as appended or as subsequently amended, but merely to clarify and exemplify the disclosure.

For a more complete understanding of the present disclosure, reference is now made to the following drawings in which:

FIG. 1 is a flowchart with exemplary method steps that may be used to implement some aspects of the present disclosure.

FIG. 2 is a schematic design of components that may be implemented in some embodiments of the present disclosure.

FIG. 3 illustrates an exemplary embodiment of the present disclosure where a wireless FOB is housed within a securing apparatus that is then inserted into the actuator module.

FIG. 4 illustrates an exemplary embodiment of the present disclosure where the wireless FOB is inserted into the actuator module

FIG. 5 illustrates an alternate embodiment of the present disclosure.

FIG. 6 illustrates another alternate embodiment of the present disclosure where more than one wireless FOB can be used.

### DETAILED DESCRIPTION OF THE PRESENTLY PREFERRED AND ALTERNATE EMBODIMENTS

Various aspects and embodiments of the present disclosure will now be described in detail with reference to the accompanying figures. Certain terminology is used herein for convenience only and is not to be taken as a limitation on the present disclosure. The terminology includes the words specifically mentioned, derivatives thereof and words of similar import. The embodiments illustrated below are not intended to be exhaustive or to limit the disclosure to the precise form disclosed. These embodiments are chosen and described to best explain the principle of the disclosure and its application and practical use and to enable others skilled in the art to best utilize the disclosure.

The following definitions are given hereunder to better understand the terms used in the specification:
“FOB” as used herein and sometimes referred to as “Wireless FOB remote” refers to a device that can be used to send a programmed coded signal to a receiver in a security system. For example, it can include but is not limited to a car locking system, alarm system, or electric garage door/gate opener system.

The present disclosure describes a method and apparatus for actuating one or more wireless FOB remote(s) based on specific user pre-programmed times. The advantage of this device is that it can utilize existing FOBs to automatically lock your vehicle, alarm; close garage without requiring manual intervention after a timer is set. Additionally, the apparatus is compatible with most existing systems without requiring any modifications to them and in some embodiments the coded signal may be programmed into the device so that the same functionality may occur without the incorporation of the FOB after it is programmed.

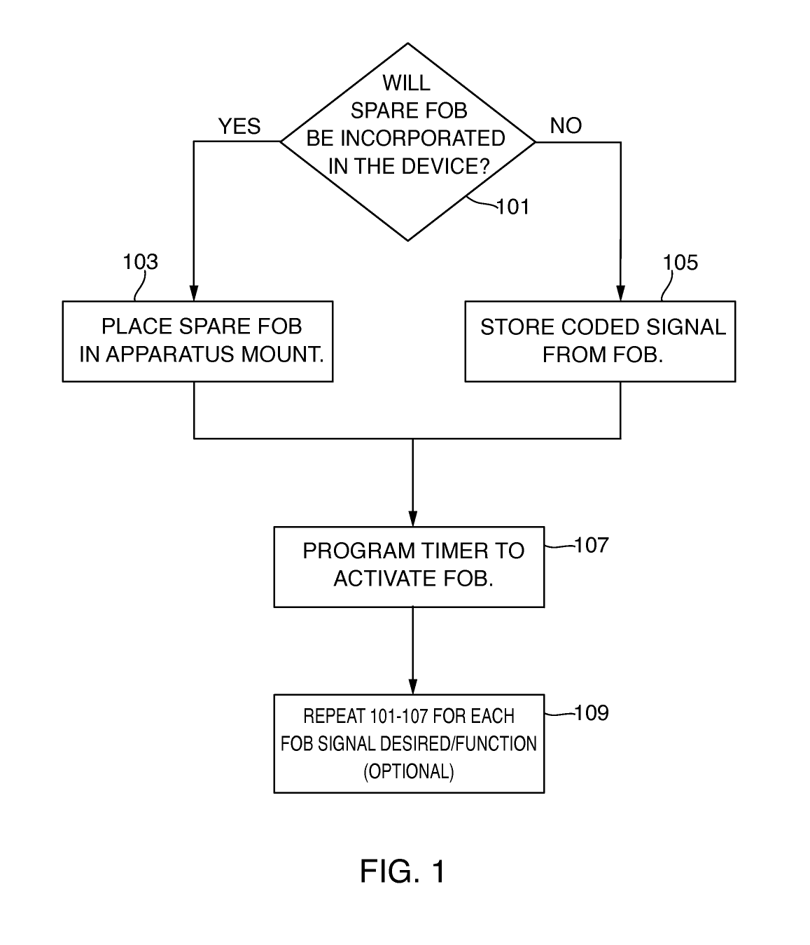

Referring now to FIG. 1, At 101, a flowchart is used to illustrate exemplary method steps that may be used to implement some aspects of the present disclosure. At 105, in some embodiments of the present disclosure, the user may record at least one coded signal into the memory in the apparatus when a spare FOB is not used. When more than one coded signal may be recorded in the system, the processor may assign a number that corresponds with each coded signal to allow the user to set up a different time for each FOB as it may be desired by the user. For example, when the coded signal is used for the locking system of a garage door and a second signal is for an automobile locking system, it may be desired that one signal is sent prior to the other one.

At 103, when a user prefers to use a spare FOB in the apparatus or when the embodiment does not include memory and a processor, the user may place a FOB in a receptacle that can be adjusted to accommodate different shapes for different FOBs. In some embodiments, more than one FOB receptacle may be included to allow for various FOBs. At 107, the user may program different times in which actuation of the FOB is desired. In some embodiments, the functionality may be a single function such as closing the garage door or locking the automobile. In additional embodiments, a timer may be programmed to perform a variety of functions or to actuate multiple FOBs 109 causing the signal from the FOB to be sent to the respective receivers in each system.

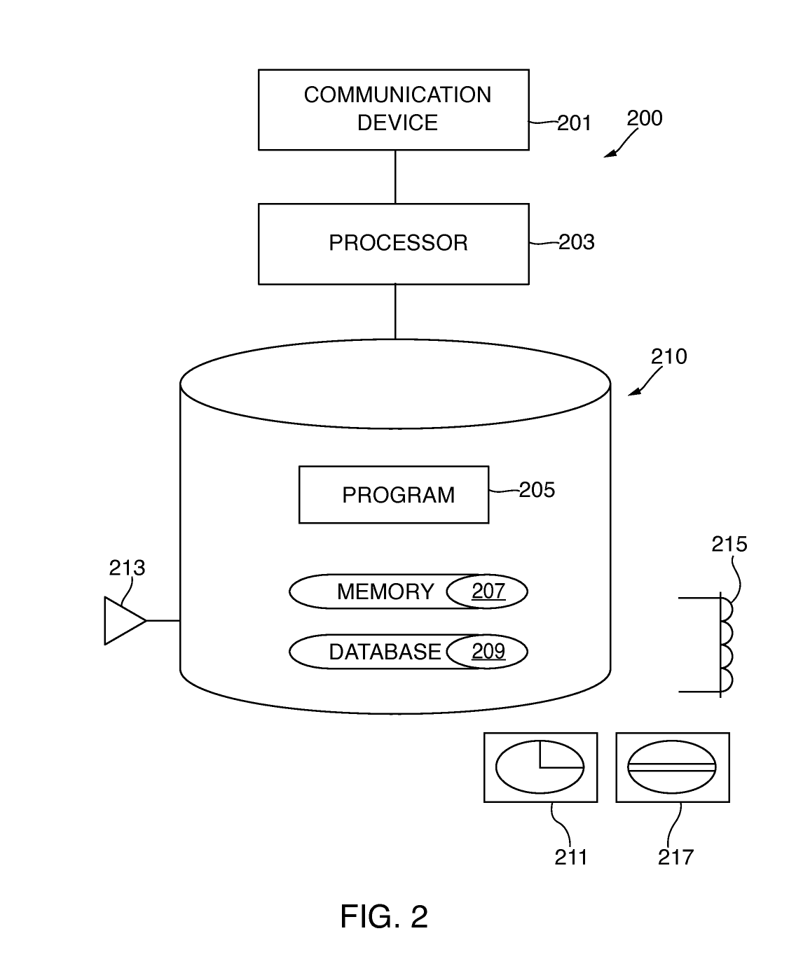

Referring now to FIG. 2, a controller that may be used by some embodiments of the present disclosure is illustrated. The controller 200 includes a processor 203, which may include one or more processor components coupled to a communication device 201. The communication device may be configured to communicate information via a communication channel. The communication device may be used to electronically transmit and receive digital data related to the functions discussed herein. For example, where the timer 211 used by the device is included in a Smartphone application, or when the Smartphone is used as an interface for the user to program the processor of the device.

The communication device 201 may also be used to communicate, for example, with one or more human readable display devices, such as, for example: an LCD panel, a LED display or other display device or printer. In some embodiments, a touch screen is utilized also functioning as the human interface with apparatus.

The processor 203 is also in communication with a memory storage device 210. The storage device 210 may comprise any appropriate information storage device, including combinations of magnetic storage devices (e.g., magnetic tape, radio frequency tags, and hard disk drives), and/or semiconductor memory devices such as Random Access Memory (RAM) devices and Read-Only Memory (ROM) devices 207.

The storage device 210 can store a program 205 for controlling the processor 203. The processor 203 performs instructions of the program 205, and thereby operates in accordance with the present disclosure. For example, the processor 203 may receive more than one coded signal and tag it with a number to assign it to a specific time as it may be programmed by the user. The storage device 210 can also store different functions for each coded signal and FOB used in the system in one or more databases 205.

At 213 a power source is depicted. The apparatus may include a USB cable, DC/AC adapter plug or may be battery operated. At 215, an actuating device, such as for example an electrical solenoid actuator with a plunger capable of pressing a button in an FOB and at 217 a FOB receptacle is depicted. The number of devices may vary depending on the number of FOBs that the apparatus is designed to incorporate. However, when the coded signal is recorded into the system, some embodiments may not require a part to actuate the FOB but instead an antenna may be incorporated in the communication device for transmitting the coded signal to the receiver of the security/locking system. Additionally, some embodiments may additionally incorporate a device to amplify the coded signal, such as for example an antenna or conductive material, such that the reach of the apparatus in relation to the locking/security system can increase.

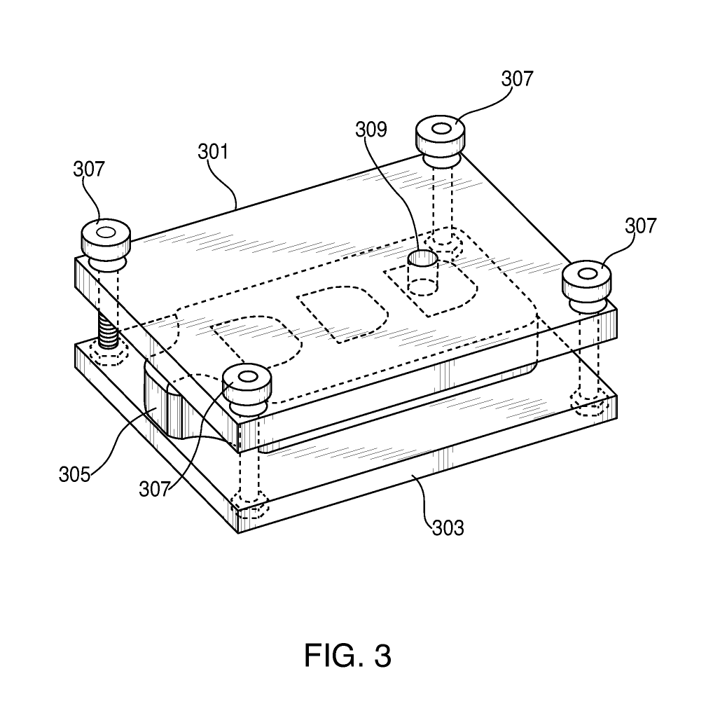

Referring now to FIG. 3, an exemplary embodiment of the present disclosure where a wireless FOB is housed within a securing apparatus which is then inserted into the actuator module. At 301 a maximal plate is depicted. At 305 a conventional FOB remote for an automobile is depicted. FOB 305 is placed between maximal plate 301 and basal plate 303. FOB 305 is secured via clockwise rotation of a plurality of securing agents 307 found at the distal edges of maximal plate 301. The “lock” button on FOB 305 is aligned with FOB actuator aperture 309 found at the proximal end of horizontal maximal plate 301.

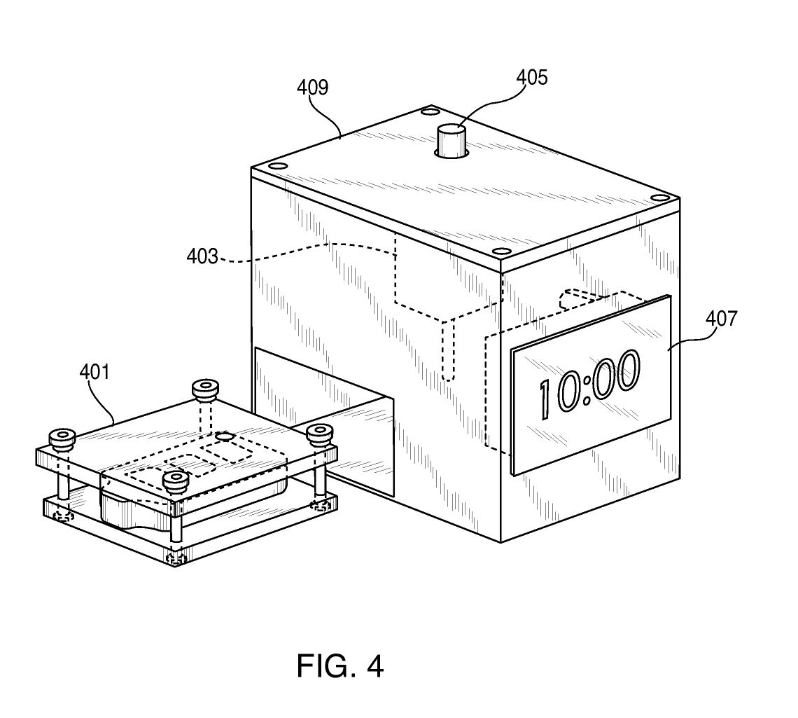

Referring now to FIG. 4, an exemplary embodiment of the present disclosure where the wireless FOB is inserted into the actuator module is depicted. At 401 a FOB securing apparatus is depicted. Refer to FIG. 3 for the composition and components of FOB securing apparatus 401. This disclosure utilizes the vehicles spare remote keyless entry FOB by placing it in a device that can be pre-programmed to automatically actuate the “lock” button on the key FOB. At 403 an electrical solenoid actuator is depicted. The actuator may act in conjunction with a plunger 405 to cause a button on in the FOB to be pressed thereby sending a coded signal.

At 401, the FOB is secured via the apparatus. Securing apparatus 401 is then placed inside actuator module 409 and perpendicularly aligned plunger 405. Securing apparatus 401 is comprised of an aperture located at immediately above the “lock” button of the FOB, which allows plunger 405 to penetrate the aperture to press the “lock” button on the FOB when electrical solenoid actuator 403 is engaged.

The apparatus may function once a timer 407 is programmed by the user. A timer 407 may include for example, a 24 hour panel clock module with programmable output pulse time or a programmable light switch timer with a programmable output. Once the timer sends a signal, actuator 403 will activate and then trigger the activation of plunger 405, with sufficient force to press the “lock” button on the FOB sending a coded signal to perform the lock function.

The apparatus may be strategically placed in the user's house, close enough to where the vehicle will be parked so the signal from the key FOB can be received by the vehicle. However, in some embodiments a signal amplifier may be used to increase the reach of the signal. A plunger manual activation access port 405 can be used in some embodiments, to manually activate the “lock” button on the key FOB to test for proper location and functionality. When a location is found the device may be connected to a power source. The timer may then be powered on and the correct time can be manually set. Battery back-up may additionally be incorporated in some embodiments to retain time in the event of a power loss. In addition to setting the correct time one or more alarm times may be programmed. This is the time that the device can automatically actuate the plunger which in turn will press the desired button, for example the “lock” button on an automobile key FOB.

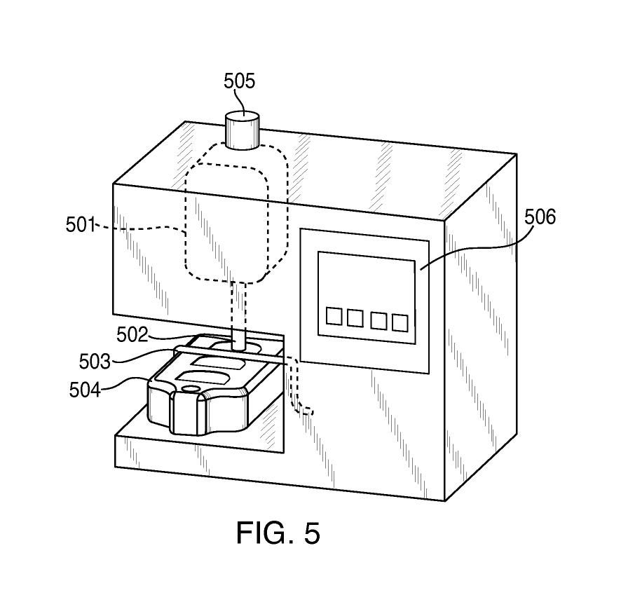

Referring now to FIG. 5, an alternate embodiment of the present disclosure is depicted. This disclosure utilizes the vehicles spare remote keyless entry FOB by placing it in a device that can be pre-programmed to automatically actuate the “lock” button on the key FOB. At 501 an electrical solenoid actuator is depicted. The actuator may act in conjunction with a plunger 505 to cause a button in the FOB to be pressed thereby sending the coded signal. At 503, an adjustable strap may be used to house the FOB. However, a depression in the base of the apparatus or a molded holder along with alignment mechanisms may also be used in some embodiments to make sure there is proper alignment and the FOB is secure. In additional embodiments, a pad of a silicone based material that is sticky enough to prevent sliding of the FOB remote when it is actuated may be used. Other alternatives may include for example, a pad that can receive a piece of Velcro® tape that mates with the other piece bonded to the FOB remote.

At 504, a conventional FOB remote for an automobile is depicted. The apparatus may function once a timer 506 is programmed by the user. A timer 506 may include for example, a 24 hour panel clock module with programmable output pulse timer or a programmable light switch timer with a programmable output. Once the timer sends a signal, an actuator such as a solenoid can be activated to then move a plunger with sufficient pressure to press a “lock” button which is placed and aligned underneath the plunger 502 to press a button of the wireless FOB remote causing the coded signal to perform the locking function.

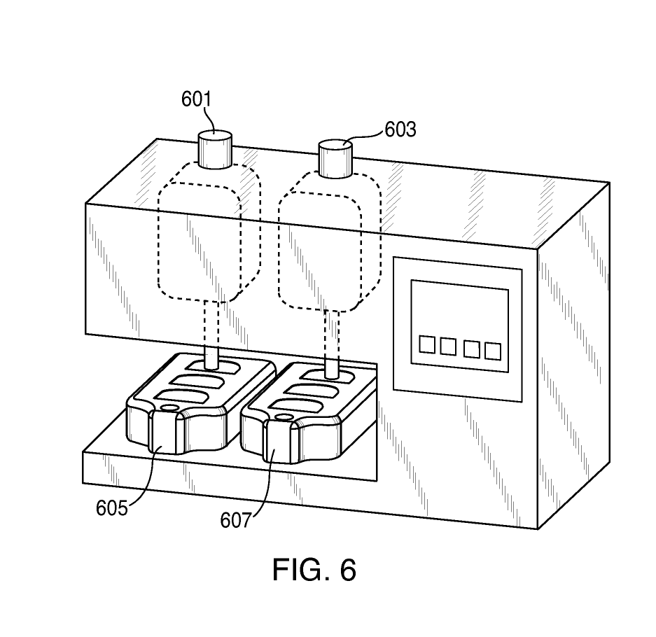

Referring now to FIG. 6, another exemplary embodiment of the present that can incorporate two FOBs is depicted. In some embodiments where two or more FOBs are used, it is possible that one plunger can cause actuators to press a button in each of the FOBs. However, more than one plunger and actuators 601, 603 may be used in some embodiments as it may be desired when the timer is capable of being programmed for more than one specific time for each of the remote FOBs 605, 607 used.

What is claimed is:

1. An apparatus capable of receiving one or more remote FOBs, the apparatus comprising: a receptacle for receiving at least one wireless FOB remote, wherein said receptacle can allow a user to adjust the position of said wireless FOB remote in relation to a button in said FOB and an actuator in said apparatus; a programmable timer capable of sending a signal to an actuator at a user programmed time, wherein said signal can cause said actuator to apply sufficient pressure to activate said button on said wireless FOB remote that is positioned perpendicularly to said actuator; a power source to provide power to said timer and said actuator of said apparatus; a user interface to allow the user to program said timer.

2. The apparatus of claim 1 wherein said receptacle comprises a housing unit.

3. The apparatus of claim 1 wherein said receptacle comprises a plurality of horizontal plates to be positioned above and below said FOB remote to prevent said FOB remote from sliding upon pressure being applied from said actuator; said horizontal plates comprised of a plurality of securing agents positioned at the distal ends of said plates, wherein said securing agents are secured via clockwise rotation, an aperture to be aligned with the lock button of said FOB fastened via said securing agents, wherein said FOB is positioned perpendicular to said actuator.

4. The apparatus of claim 1, wherein said actuator comprises an electrical system.

5. The apparatus of claim 1, wherein said actuator comprises a pneumatic system.

6. The apparatus of claim 1, wherein said actuator comprises a plunger.

7. The apparatus of claim 1 additionally comprising a signal amplifying component capable of increasing the range of said wireless FOB remote.

8. The apparatus of claim 1, wherein the power source comprises an AC adapter plug.

9. The apparatus of claim 1, wherein said power source comprises a DC adapter plug.

10. The apparatus of claim 1, wherein said power source comprises a rechargeable battery.

11. The apparatus of claim 1 additionally comprising a processor in logical communication with a digital storage and capable of using executable software stored in said digital storage and operative with said processor and a receiver to record one or more coded signals from a wireless FOB remote.

12. The apparatus of claim 1 additionally comprising a means of communicating with a network.

13. The apparatus of claim 1, wherein said means for communicating with a network includes a USB connector.

14. The apparatus of claim 1, wherein the user interface is an LCD touch screen; said LCD touch screen is capable of displaying preprogrammed alerts to the user.

15. The apparatus of claim 1, wherein the actuator comprises an electrical system.

16. A method of actuating one or more wireless FOB remotes, the method comprising: aligning at least one wireless FOB remote's button, in contact with or proximate to, an actuator, programming a timer in logical sequence with said actuator, sending a signal at the pre-programmed time to a receiver in said actuator triggering said actuator to apply enough pressure for activating the button in said wireless FOB remote.
